(19) United States
(12) Patent Application Publication
(10) Pub. No.: US 2010/0255284 A1
(43) Pub. Date: Oct. 7, 2010

(54) PANEL

(76) Inventor: Jong-Young Park, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/744,272

(22) PCT Filed: Nov. 6, 2008
(86) PCT No.: PCT/KR08/06535

§ 371 Date: May 21, 2010

(30) Foreign Application Priority Data
Nov. 23, 2007 (KR) 10-2007-0120392

(51) Int. Cl. E04C 2/26; E04C 2/292; B32B 15/20

(52) U.S. Cl. 428/312.8

(57) ABSTRACT

A panel for reinforcing strength is disclosed, which is able to maintain an inherent strength of a panel member by attaching an aluminum foamed panel on one side of a panel member in a state that marble, wooden material, aluminum material or something like that is formed in a plate shape. The patent of the present invention is well applied for various purposes depending on its characteristic.

### TECHNICAL FIELD

The present invention relates to a panel for reinforcing strength, and in particular to a panel for reinforcing strength which is able to maintain an inherent strength of a panel member by attaching an aluminum foamed panel on one side of a panel member in a state that marble, wooden material, aluminum material or something like that is formed in a plate shape. The patent of the present invention is well applied for various purposes depending on its characteristic.

### BACKGROUND ART

Wooden material, stone material, marble material or something like that might be applied for an internal or external decoration material of a building or a floor material. In recent years, marble material is widely used as an interior material is advanced.

However, in case that an expensive marble is used for an internal or external decoration material, an architecture structure might cost a lot, and as a marble material is heavy, and its installation needs a hard work, and a construction work might be further increased depending on a design change of a building.

In addition, a synthetic resin material is generally used for an internal decoration material of a bus or a subway train. In this case, when a fire occurs, a lot of causality might occur.

Furniture is generally made of an expensive wooden material. In this case, an economic burden increases as well.

### DISCLOSURE OF INVENTION

### Technical Problem

Accordingly, it is an object of the present invention to provide a panel which overcomes the problems found in the conventional art.

It is another object of the present invention to provide a panel which is able to maintain an inherent strength of a panel member by attaching an aluminum foamed panel on one side of a panel member made of a marble material, a wooden material, a synthetic resin, a ceramic material or something like that, and an economic cost can be decreased as a strength increases, and a weight decreases. An easier installation by a worker can be performed.

### Technical Solution

To achieve the above objects, in a panel for reinforcing strength, there is provided a panel characterized in that one side of a resin plate 400 is adhered to either one side or both sides of an aluminum foamed panel 200 using an adhesive, and a panel member 100 is adhered to the other side of the resin plate 400 using an adhesive 300.

The panel member 100 is formed of one selected from the group consisting of a stone material, a wooden material, a metallic material, a synthetic resin material, an aluminum material, a ceramic material, and an inflammable rubber plate material.

A plurality of pores are formed in the panel member 100.

The adhesive 300 is impregnated in a net shaped fiber panel.

### ADVANTAGEOUS EFFECTS

The panel for reinforcing strength according to the present invention has the following advantages.

First, when the present invention is applied to an internal or external decoration of a building, a construction can be easily performed since it is righter than a conventional marble material, and a unit cost is low. The present invention can be easily adapted for the purposes of various interiors.

Second, when the present invention is applied to a bulletproof vest, an aluminum foamed panel is able of absorb an impact when a bullet hits a surface of a panel member, and it is possible to prevent a bullet from passing through with the help of a metallic plate, and a strength as well as an impact absorption are enhanced.

Third, when the present invention is applied to a floor material of a train or a bus, a fire might be prevented, and a corrosion prevention function can be obtained even when it is used for a long time, and an excellent noise absorption function can be obtained. In particular, when an upper most surface is made of a panel member of an inflammable material, a fire can be surely prevented.

### BRIEF DESCRIPTION OF THE DRAWINGS

FIG. 1 is a disassembled perspective view illustrating a state that a panel member and an aluminum foamed member are adhered according to an embodiment of the present invention.

FIG. 2 is a side cross sectional view of FIG. 1.

FIG. 3 is a disassembled perspective view illustrating a state that an aluminum foamed panel is attached between a panel member and a panel member according to the present invention.

FIG. 4 is a side cross sectional view of FIG. 3.

FIG. 5 is a disassembled perspective view illustrating a state that a resin plate is provided in an adhesive used for adhering a panel member and an aluminum foamed panel according to the present invention.

FIG. 6 is a side cross sectional view of FIG. 5.

FIG. 7 is a side cross sectional view illustrating a state that pores are formed in a surface of a panel member according to the present invention.

FIG. 8 is a side cross sectional view illustrating a state that a high strength metallic plate is disposed in an adhesive according to the present invention.

FIG. 9 is a side cross sectional view illustrating a state that a net shaped fiber panel is disposed in an adhesive according to the present invention.

### BEST MODE FOR CARRYING OUT THE INVENTION

In the present invention, in a panel for reinforcing strength, there is provided a panel characterized in that one side of a resin plate 400 is adhered to either one side or both sides of an aluminum foamed panel 200 using an adhesive, and a panel member 100 is adhered to the other side of the resin plate 400 using an adhesive 300.

### Mode for the Invention

The preferred embodiments of the present invention will be described with reference to the accompanying drawings. In the following descriptions, in case that it is judged that a related prior art might be make the subject of the present invention unclear, the detailed descriptions might be omitted.

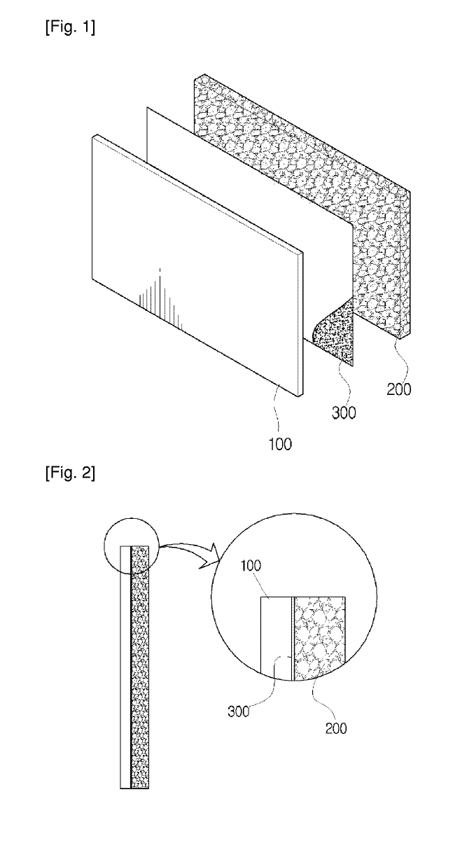

As shown in FIG. 1 or 2, the panel according to the present invention comprises a plate shaped panel member 100, and an aluminum foamed panel 200 which is attached to one side of the panel member 100 with an adhesive 300 for thereby reinforcing the strength of the panel member 100.

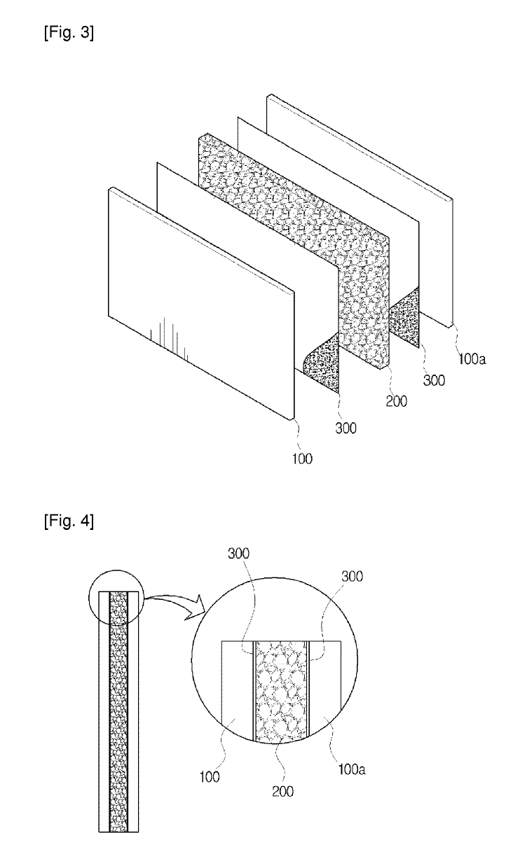

As shown in FIG. 3 or 4, the aluminum foamed panel 200 is attached between a pair of panel members 100 and 100a with an adhesive 300.

Here, the aluminum foamed panel 200 is a known art and is made in a plate shape by foaming aluminum with its surface being formed of a plurality of non-uniform pores.

The panel member 100 might be made of a certain material such as a stone material, a marble material, a wooden material, a metallic material, a synthetic resin material, an aluminum material, a ceramic material, an inflammable rubber material or something like that.

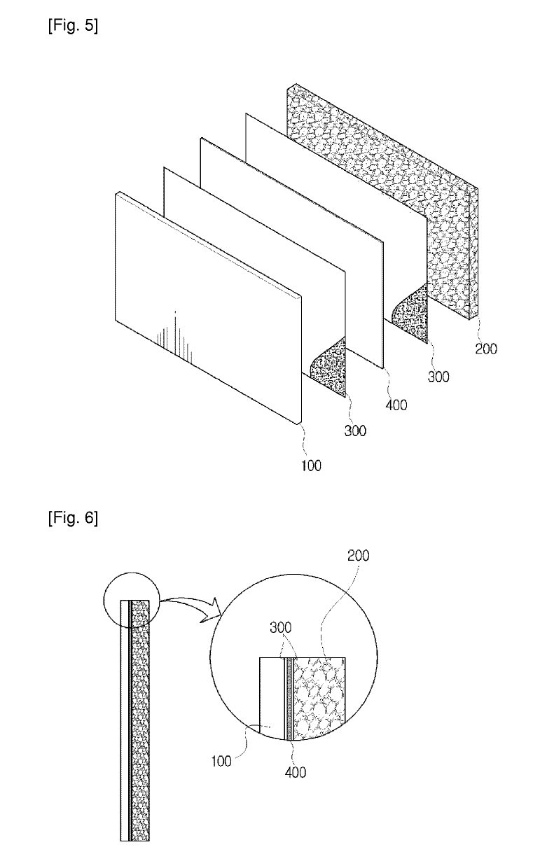

As shown in FIG. 5 or 6, it is preferred that an aluminum foamed panel 200 and a panel member 100 are adhered to both sides of the resin plate 400 coated with an adhesive on its both sides.

When the resin plate 400 has a thermal melting or self-adhering force, the above adhesive 300 is not needed, so it can be directly attached to the panel member 100 or the aluminum foamed panel 200.

The resin plate 400 is adapted so as to make the non-uniform surface uniform since the surface of the aluminum foamed panel 200 might be non-uniform due to a foaming manufacturing method.

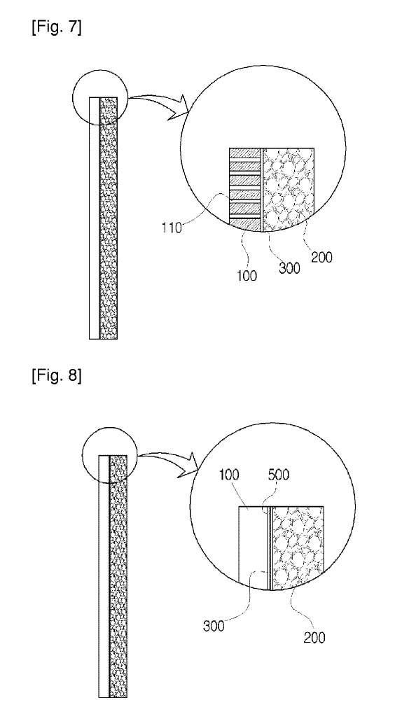

As shown in FIG. 7, a plurality of pores 110 are formed on a surface of the panel member 100 for thereby absorbing noises.

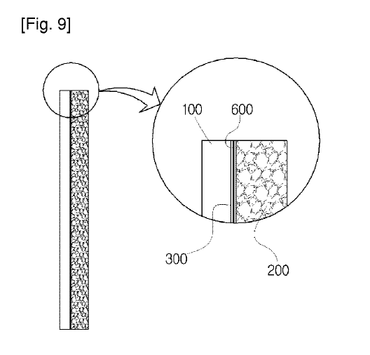

As shown in FIG. 8, it is preferred that the panel member 100 and the aluminum foamed panel 200 are attached in a state that a net shaped fiber panel 500 is impregnated so as to enhance an adhering force of the adhesive 300.

As shown in FIG. 9, it is preferred that the panel member 100 and the aluminum foamed panel 200 might be adhered in a state that the adhesive 300 is adhered to both sides of the metallic plate 600 having a high strength.

A panel member of an inflammable rubber material might be further adhered to an upper most surface of the panel member 100 for thereby implementing a reliable safe from fire.

The panel for reinforcing strength according to embodiments of the present invention will be described.

### FIRST EMBODIMENT

When the present invention is applied to an internal or external decoration of a building, the panel is formed of a marble material panel member 100+an adhesive 300+a resin plate 400+an aluminum foamed panel 200.

With the above construction, weight is lighter than conventional marble material, and an installation is easier, and the unit cost is much lower.

The panel for reinforcing strength according to the present invention might be applied to an internal or external decoration of a building as well as various interior purposes such s a wall body or a ceiling or something like that.

The resin plate 400 and the aluminum foamed panel 200 might be adhered by a self-adhering force based on a melting of the resin plate 400 or an adhesive 300 or an engaging member.

### SECOND EMBODIMENT

When the present invention is applied to a bulletproof material, the panel according to the present invention is formed of a ceramic material panel member 100+an adhesive 300+a metallic plate 600+an aluminum foamed panel 200.

So, when a certain impact is applied to the surface of the ceramic material panel member 100, the aluminum foamed panel 200 absorbs the impact, and the metallic plate 600 prevents the thing from passing through.

The metallic plate 600 and the aluminum foamed panel 200 might be adhered by means of an adhesive 300 or a certain engaging member.

### THIRD EMBODIMENT

When the present invention is applied to furniture, the panel according to the present invention is formed of a wooden material panel member 100+an adhesive 300+an aluminum foamed panel 200+an adhesive 300+a wooden material panel member 100a.

The wooden material panel members 100 and 100a support the aluminum foaled panel 200 for thereby significantly enhancing durability while achieving a noise absorption function.

### FOURTH EMBODIMENT

When the present invention is applied to a floor material of a train or a bus, the panel according to the present invention is formed of an aluminum material panel member 100+an adhesive 300+an aluminum foamed panel 200+an adhesive 300+an aluminum material panel member 100a.

So, the panel according to the present invention can be prevented from fire, and a corrosion prevention effect can be obtained when it is used for a long time, and a noise absorption function can be obtained as well.

### INDUSTRIAL APPLICABILITY

A panel for reinforcing strength is disclosed, which is able to maintain an inherent strength of a panel member by attaching an aluminum foamed panel on one side of a panel member in a state that marble, wooden material, aluminum material or something like that is formed in a plate shape. The patent of the present invention is well applied for various purposes depending on its characteristic.

1. In a panel for reinforcing strength, a panel characterized in that one side of a resin plate 400 is adhered to either one side or both sides of an aluminum foamed panel 200 using an adhesive, and a panel member 100 is adhered to the other side of the resin plate 400 using an adhesive 300.

2. The panel of claim 1, wherein said panel member 100 is formed of one selected from the group consisting of a stone material, a wooden material, a metallic material, a synthetic resin material, an aluminum material, a ceramic material, and an inflammable rubber plate material.

3. The panel of claim 2, wherein a plurality of pores are formed in the panel member 100.

4. The panel of claim 1, wherein said adhesive 300 is impregnated in a net shaped fiber panel.
